(19) United States
(12) Patent Application Publication
(10) Pub. No.: US 2023/0354733 A1
(43) Pub. Date: Nov. 9, 2023

(54) HYDRAULIC ADJUSTMENT DEVICE

(71) Applicant: Weber-Hydraulik GmbH, Konstanz (DE)

(72) Inventors: Nathalie WOERNER, Konstanz (DE); Hans-Wilhelm WEISS, Wutach-Lembach (DE)

(73) Assignee: Weber-Hydraulik GmbH, Konstanz (DE)

(21) Appl. No.: 18/144,938

(22) Filed: May 9, 2023

(30) Foreign Application Priority Data
May 9, 2022 (DE) 102022111489.9

(51) Int. Cl. A01B 63/111; A01B 59/06; A01B 63/10

(52) U.S. Cl. CPC A01B 63/1117; A01B 59/066; A01B 63/1006

(57) ABSTRACT

In a hydraulic adjustment device, preferably for transverse adjustment of the lower links of a three-point power lift on an agricultural machine, with two selectively controllable hydraulic cylinders and a hydraulic control circuit for actuating them, a control circuit with a pressure control device for generating an adjustable control pressure in dependence on an electrical control signal is provided, and a pressure-controlled changeover valve is connected to the pressure control device and, when a first control pressure value is applied, assumes a first switching position in which a first cylinder is connected to a pressure sink and the second cylinder is connected to a pressure source, and, when a second control pressure value is applied which is higher than the first control pressure value, assumes a second switching position in which the first cylinder is connected to the pressure source and the second cylinder is connected to the pressure sink.

### CROSS-REFERENCE TO RELATED APPLICATIONS

This application claims priority to German Patent Application No. 10 2022 111 489.9, filed May 9, 2022, which is incorporated herein by reference as if fully set forth.

### TECHNICAL FIELD

The present invention relates to a hydraulic adjustment device, in particular for transverse adjustment of the lower links of a three-point power lift on an agricultural machine, with two selectively actuatable hydraulic cylinders and a hydraulic control circuit for actuating the hydraulic cylinders.

### BACKGROUND

In the case of agricultural machines, such as tractors or the like, implements such as mowers, plows, harvesters and the like are mounted at the front or rear using a so-called three-point hitch. A three-point hitch is described, for example, in EP 1 116 430 A1. Together with a hydraulic system for raising and lowering the implement, such a three-point hitch is also referred to as a three-point power lift.

A three-point hitch usually has two lower links, which are pivotably hitched at corresponding hitch points on the machine, and an upper link that can likewise be pivoted. It must be possible to adjust the lower links transversely here in order to be able to adapt the distance between the lower links to the width of the attachment. Solutions for such width adjustment have been realized using chains or T screws. However, a hydraulic transverse adjustment of the lower links is advantageous. In this case, the two lower links are each connected to a hydraulic cylinder running at an angle in the lateral direction. By simultaneously extending or retracting the hydraulic cylinders and moving the two lower links correspondingly in the transverse direction, the distance between them can be reduced or increased to match the width for receiving the attachment in question.

### SUMMARY

It is one of the objects of the present invention to specify a hydraulic adjustment device and an associated hydraulic control circuit which allows two hydraulic cylinders to be actuated selectively in a simple way. In particular, the adjustment device or its hydraulic control circuit should get by with as few electrical actuation signals as possible.

The object is achieved by a device with one or more of the features disclosed herein. Advantageous embodiments can be found in the description and claims that follow.

In an adjustment device of the type mentioned at the outset, it is provided in accordance with the invention that the control circuit has a pressure control device for generating an adjustable control pressure in dependence on an electrical control signal and a pressure-controlled changeover valve which is connected to the pressure control device and, when a first control pressure value is applied, assumes a first switching position in which a first of the hydraulic cylinders is connected to a pressure sink and the second hydraulic cylinder is connected to a pressure source and, when a second control pressure value is applied which is higher than the first control pressure value, assumes a second switching position in which the first hydraulic cylinder is connected to the pressure source and the second hydraulic cylinder is connected to the pressure sink.

If pressure is applied to one of the hydraulic cylinders while the second is connected to the pressure sink and can thus retract, in the case of a three-point hitch both lower links are transversely adjusted in the same direction, an attachment is thus transversely adjusted by the three-point hitch. The locking circuit according to the invention thus makes it possible to execute a transverse adjustment selectively in one or the other direction with a single electrical control signal, depending on the switching position into which the pressure-controlled changeover valve is switched by adjustment of the switching pressure. Thus, the present invention makes it possible to perform a transverse adjustment of an attachment in an agricultural machine in a simple manner.

In an advantageous development, it can additionally be provided that the pressure-controlled changeover valve, when a third control pressure value is applied that differs from the first and second, assumes a third switching position in which both hydraulic cylinders are connected to the pressure source or to the pressure sink. In this third switching position, both hydraulic cylinders can thus be extended or retracted simultaneously. This makes it possible to adjust the width of the lower links in the case of a three-point hitch. Thus, in a three-point hitch of an agricultural machine, the invention enables both a transverse adjustment and a width adjustment of the lower links to be carried out with a single control signal. Preferably, the third control pressure value is selected to be lower than the first control pressure value or the second control pressure value. Since a width adjustment of the lower links of a three-point hitch is usually performed without load, this can thus be carried out at the lowest control pressure value. In this case, the control pressure can be used at the same time not only to switch the changeover valve but also to extend the hydraulic cylinders, i.e., the hydraulic cylinders are only pressurized with the control pressure and not with the full working pressure of the pressure source.

A further advantage results if the control circuit additionally has an electrically switched changeover valve which, either directly or via pressure-controlled valves, in a first switching position interrupts a connection to the pressure source or the pressure sink switched via the pressure-controlled changeover valve and connects through in a second switching position.

On the one hand, a safety function such as an emergency stop can be implemented here by preventing an adjustment of the hydraulic cylinders by interrupting a connection to the pressure source and pressure sink and thus holding their position safely. In addition, interruption of the switched connection in the third switching position enables the direction of the width adjustment to be switched, i.e., either simultaneous retraction or simultaneous extension of the hydraulic cylinders for width adjustment. As already mentioned, the extension can be carried out here with the aid of the control pressure, which is lower than the working pressure supplied by the pressure source due to the pressure control device.

In order to be able to adjust the hydraulic cylinders with the aid of the control pressure, it is expedient to connect the control pressure from the pressure control device directly to both hydraulic cylinders via check valves at least in the third switching position. The check valves serve in particular to prevent the working pressure from returning to the outlet of the pressure control device if the full pressure of the pressure source is applied to one of the hydraulic cylinders during operation of the attachment.

In a development of the invention, it can also be provided that the control pressure from the pressure control device is connected directly to either of the two hydraulic cylinders via check valves and a further, electrically switchable changeover valve, at least in the third switching position. Thus, in the third switching position, i.e. for width adjustment of the lower links, the latter can be laterally adjusted separately from one another. This can be useful for adjusting the position of the lower links for coupling an attachment to the position of their hitch points. This avoids time-consuming, precise maneuvering with the work machine.

Expediently, the pressure control device can be formed by a pressure control valve or by an adjustable pressure-limiting valve with a flow resistor.

Furthermore, it can be expedient to provide that load signal lines branch off from pressure lines leading to the hydraulic cylinders and are connected to a load flow signal system of the pressure source, and that the pressure source is embodied as a volume-flow-controllable hydraulic pump. Many agricultural machines today have a corresponding load pressure signaling or load sensing system (LS system). In this way, the pressure or volume flow of the hydraulic pump can be adapted to the conditions required by the consumer. The pump therefore only has to deliver the volume flow that is currently required for all active consumers. This avoids power losses that would occur if the hydraulic pump always delivered at maximum capacity even when the volume flow was throttled.

If the pressure-controlled changeover valve is designed as a proportional valve in such a way that a changeover movement from the first switching position to the second switching position is proportional to the control pressure, an adjustment speed of the relevant lower link can be changed via the control pressure.

The hydraulic adjustment device specified by the present invention can be used for all kinds of applications in which two hydraulic cylinders are to be deflected selectively either in the same direction or in different, opposite directions. However, a preferred application relates to a so-called three-point power lift of an agricultural machine. This has two laterally pivotable lower links, each of which can be transversely adjusted via a hydraulic cylinder, as well as a hydraulic control circuit for controlling the hydraulic cylinders. According to the invention, it is provided here that the control circuit has a pressure control device for generating an adjustable control pressure in dependence on an electrical control signal and a pressure-controlled changeover valve which is connected to the pressure control device and which, when a first control pressure value is applied, assumes a first switching position in which a first of the hydraulic cylinders is connected to a pressure source and the second hydraulic cylinder is connected to a pressure sink, and, when a second control pressure value is applied which is higher than the first control pressure value, assumes a second switching position in which the first hydraulic cylinder is connected to the pressure sink and the second hydraulic cylinder is connected to the pressure source.

Preferably, the three-point power lift can be equipped with a hydraulic adjustment device according to one or more of the features disclosed herein. The hydraulic cylinders of the three-point power lift are expediently designed as single-acting cylinder/piston units with spring return. Instead of using a return spring, the return can also be effected by gas pressure, for example.

### BRIEF DESCRIPTION OF THE DRAWINGS

Further advantages and features of the present invention will become apparent on the basis of the following description of exemplary embodiments with reference to the figures, in which:

FIG. 1 shows the hydraulic diagram of a hydraulic adjustment device in a first exemplary embodiment,

FIG. 2 shows the hydraulic diagram of a hydraulic adjustment device in a second exemplary embodiment,

FIG. 3 shows the hydraulic diagram of a hydraulic adjustment device in a third exemplary embodiment,

FIG. 4 shows a hydraulically controlled switching valve with additional pressure safety function, which can be used in exemplary embodiments 1 to 3,

FIGS. 5A and 5B show alternative embodiments of a pressure control device by a pressure control valve (FIG. 5A) or by an adjustable pressure-limiting valve (FIG. 5B), and

FIG. 6 shows a schematic drawing of the lower links of a three-point power lift with laterally arranged hydraulic cylinders for transverse adjustment of the lower links.

### DETAILED DESCRIPTION

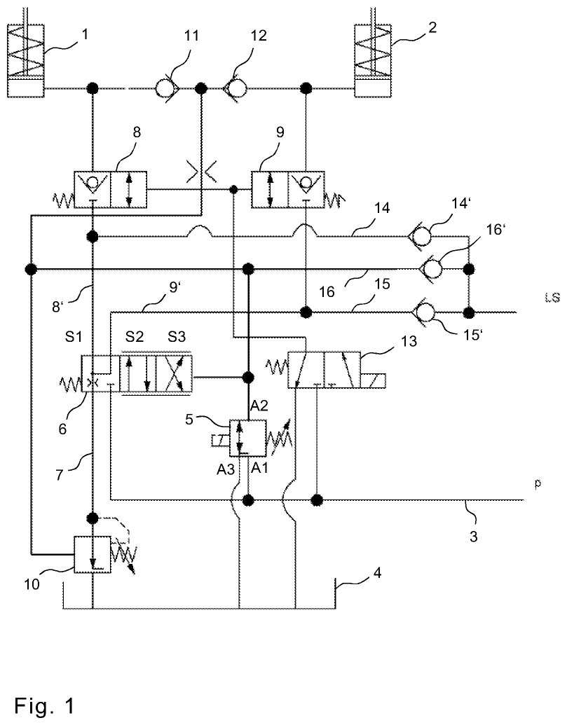

The hydraulic circuit shown in FIG. 1 comprises two single-acting hydraulic cylinders 1, 2 with spring return, which can be actuated selectively. The circuit comprises a pressure supply line 3 to which a pressure source such as the hydraulic pump of an agricultural machine is connected. A tank 4 forms the pressure sink of the hydraulic circuit.

The heart of the circuit is a pressure control valve 5, which serves as a pressure control device for generating an adjustable control pressure in dependence on an electrical input signal. The pressure control valve has a first port A1 connected to the pressure supply line 3, a second port A2 to which the adjustable control pressure is applied, and a third port A3 connected to the tank 4 via a tank return line. The port A2 is connected to the control port of a pressure-controlled changeover valve 6, which realizes the function of a 4/3-way valve. The four ports of the changeover valve 6 are connected to the pressure line 3, to a tank return line 7 and in each case to one of the two hydraulic cylinders 1, 2 via a pressure-controlled closing valve 8, 9. In the tank return line 7 between the changeover valve 6 and the tank 4 there is a pressure compensator (differential pressure valve) 10, the control input of which is connected to the port A2 of the pressure control valve 5. In addition, the port A2 of the pressure control valve 5 is directly connected to each of the two hydraulic cylinders 1, 2 via check valves 11, 12.

In addition, the circuit also comprises an electrically switched changeover valve 13 in the form of a 3/2-way valve, via which the control ports of the two pressure-controlled closing valves 8, 9 can be connected either to the pressure line 3 or to the tank 4 in order to either open the closing valves 8, 9 or, when the pressure in the control line to the tank 4 is relieved, to close them with spring return.

Load signal lines 14, 15, 16 branch off, in each case upstream of the two pressure-controlled closing valves 8, 9, from the pressure lines 8′, 9′ leading from the pressure-controlled changeover valve 6 to the hydraulic cylinders 1, 2 and from the control pressure line connected to the port A2 of the pressure control valve 5 and are connected to the LS system of the pressure source in order to adapt the delivered volume flow to the load requirement. In order to avoid a retroaction of the pressures between the load signal lines or with other possibly connected load signal lines, each of the load signal lines 14, 15, 16 is provided with a check valve 14′, 15′, 16′.

The hydraulic circuit shown thus requires only two electrical control signals, specifically for the pressure control valve 5 and the changeover valve 13, in order to selectively actuate the hydraulic cylinders 1, 2. Depending on the control pressure value p set by the pressure control valve 5, the pressure-controlled changeover valve 6 assumes one of the three switching states shown. Up to a lower control pressure value p1, the changeover valve 6 remains in the left switching position (S1), held by a return spring, in which position the two pressure lines 8′, 9′ leading to the pressure-controlled closing valves 8, 9 are connected to the tank 4 via the pressure compensator 10. The pressure compensator opens only at a switching pressure p0 which is below the control pressure value p1. As long as the control pressure p<p0, the tank return line 7 is closed and no hydraulic fluid can flow from the hydraulic cylinders 1, 2 to the tank regardless of the switching position of the closing valves 8, 9.

At a control pressure value p0<p<p1, the pressure compensator 10 opens so that the hydraulic cylinders 1, 2 are connected to the tank 4 when the closing valves 8, 9 are open, i.e. when the changeover valve 13 is energized. In this switching state, the piston rods of both hydraulic cylinders 1, 2 can retract by the force of their respective return springs. If, on the other hand, the changeover valve 13 is de-energized and the closing valves 8, 9 are thus closed, the control pressure p applied to the hydraulic cylinders 1, 2 via the check valves 11, 12 causes the piston rods of both hydraulic cylinders 1, 2 to extend.

If the control pressure is increased to a value above the control pressure value p1, the changeover valve 6 initially switches to the middle switching state (S2), in which the pressure line 8′ leading to the hydraulic cylinder 1 is connected to the tank 4 and the pressure line 9′ leading to the hydraulic cylinder 2 is connected to the pressure supply line 3. From a control pressure above an upper control pressure value p2, the changeover valve 6 switches into the right switching state (S3), in which the pressure line 8′ leading to the hydraulic cylinder 1 is connected to the pressure supply line 3 and the pressure line 9′ leading to the hydraulic cylinder 2 is connected to the tank 4. At a control pressure value p1<p<p2 and with energized changeover valve 13, the piston rod of hydraulic cylinder 1 is thus extended and the piston rod of the hydraulic cylinder 2 retracted. If the control pressure value p>p2 and the changeover valve 13 is energized, the direction of movement is reversed, i.e., the piston rod of the hydraulic cylinder 1 can retract and the piston rod of the hydraulic cylinder 2 can extend. When the changeover valve 13 is de-energized, on the other hand, the closing valves 8, 9 are closed and the pressure lines 8′, 9′ leading from the changeover valve 6 to the hydraulic cylinders 1, 2 are blocked, so that the piston position of the hydraulic cylinders 1, 2 is blocked. In this way, an emergency stop function can be realized by the changeover valve 13.

The hydraulic cylinders 1, 2, can be used in particular as a hydraulic adjustment device for transverse adjustment of the lower links 21, 22 of a three-point power lift on an agricultural machine, as shown schematically in FIG. 6. Shown here in highly simplified form are the two lower links 21, 22 of a three-point power lift, which are pivotably attached to corresponding mounting points, e.g., a hitch frame of the agricultural machine. The two hydraulic cylinders 1, 2, are each connected to one of the two lower links 21, 22 in an oblique manner in the lateral direction. By moving in the same direction, i.e. extending or retracting the piston rod of the hydraulic cylinders 1, 2 on both sides, the width between the two lower links 21, 22 can be reduced or increased. This takes place in the left switching position (S1) of the changeover valve 6, i.e., at a control pressure value p0<p<p1, wherein the width is enlarged by energizing the changeover valve 13 (retracting movement of the piston rods) and the width is reduced in the de-energized state of the changeover valve 13 (extending movement of the piston rods). When the control pressure value p1<p<p2 and the changeover valve 13 is energized, an implement coupled to the three-point hitch can be moved to the right (switching position S2) and when the control pressure value p>p2, it can be moved to the left (switching position S3). In one exemplary embodiment, the switching position S1 is assumed at a pressure of 0 to 5 bar; the switching position S2 is assumed at a pressure between 10 and 15 bar, and the switching position S3 is assumed at a pressure between 15 and 20 bar. Of course, higher or lower pressure values for the individual switching positions are also conceivable. In general, the required pressure level depends on friction values of the mechanical components, in particular the friction in the hydraulic cylinder. Preferably, the pressures are selected as in the mentioned exemplary embodiment so that an adjustment can be operated with the operating pressure of a power-controlled hydraulic pump of a tractor (LS system) in idle operation. In particular, the switching positions from S2 to S3 can be controlled here without transitions, i.e. from 10 to 15 and then from 15 to 20 bar.

The hydraulic circuit thus enables both a width adjustment of the three-point power lift and a transverse movement of the coupled implement via the transverse adjustment of the lower links. Such a transverse movement of the entire attachment or parts of the attachment, e.g., during work in the field, can be carried out with the aim of protecting the crop in the field from damage by the attachment, for example during hoeing work or the like between the crop rows.

In addition, the control circuit according to the invention makes it possible to brace the lower links relative to each other when the attachment is received, i.e. to stiffen them with respect to lateral movements. This allows the machine to be driven safely on public roads and in the field. The bracing is achieved in the left switching position (S1) of the changeover valve 6, i.e., at a control pressure value p0<p<p1, by both hydraulic cylinders 1, 2 extending against each other.

By preloading the return flow to the tank 4 via the line 7 by means of the pressure compensator 10, the risk of a vacuum occurring in hydraulic cylinders 1, 2 is reduced if the load leads the hydraulic pressure due to transverse accelerations. In this case, the preload fulfills the function of a lowering brake with a low opening pressure, so to speak. If higher preload pressures are required, the pressure compensator 10 could alternatively be replaced by two lowering brakes connected in parallel. In this case, the particular pressure from line 15 or 14 could be tapped to open the corresponding lowering brake.

Since the opening pressure p0 at which the pressure compensator 10 opens is lower than the lower switching pressure p1 of the changeover valve 6, the two valves are switched in sequence. This sequential actuation ensures that no functional overlaps can occur.

The pressure-controlled changeover valve 6 can additionally include a proportional function, i.e. the connections switched by the valve are released more or less depending on the pressure, thus effecting a pressure-dependent throttle function. This enables the cylinders 1 and 2 to be moved dynamically in the field in proportion to the pump pressure (preferably of an LS system). The maximum pump power of the hydraulic system is then available here, even if only a small amount of pump power is typically required for the adjustment device according to the invention.

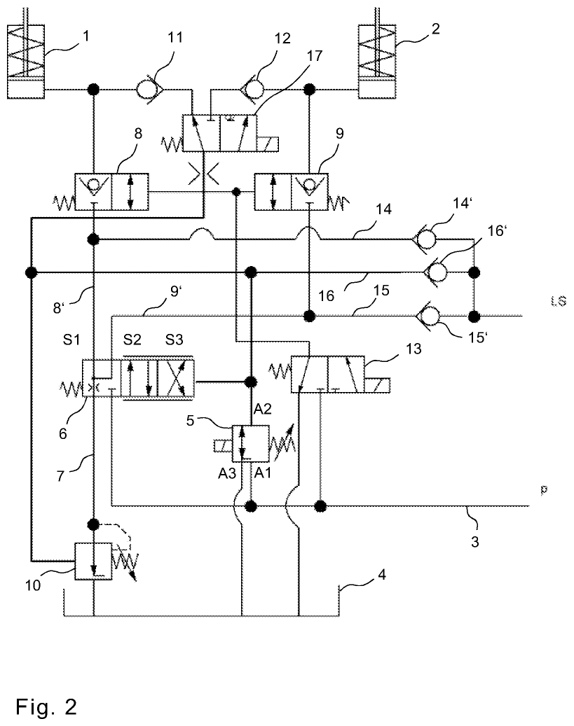

A development of the hydraulic circuit from FIG. 1 is shown in FIG. 2. There, an electric 3/2-way changeover valve is additionally installed in the control pressure line coming from port A2 of the pressure control valve 5, by means of which changeover valve the control pressure p in the left switching position (S1) of the changeover valve 6 (p0<p<p1) can be applied to only one of the two hydraulic cylinders 1, 2 selectively, instead of to both hydraulic cylinders 1, 2 simultaneously. This enables independent positioning of the lower links when coupling an attachment.

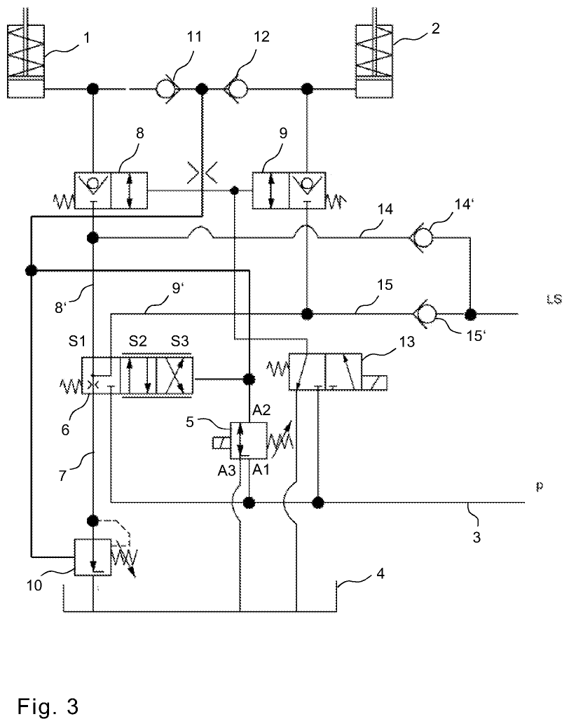

FIG. 3 shows a further modification of the hydraulic circuit of FIG. 1. Here, the load signal line 16 present in FIG. 1, which branches off from the control pressure line connected to the port A2 of pressure control valve 5, is omitted. In this way, a width adjustment or bracing of the lower links 21, 22 is possible without a pressure signal being sent to the LS system of the machine.

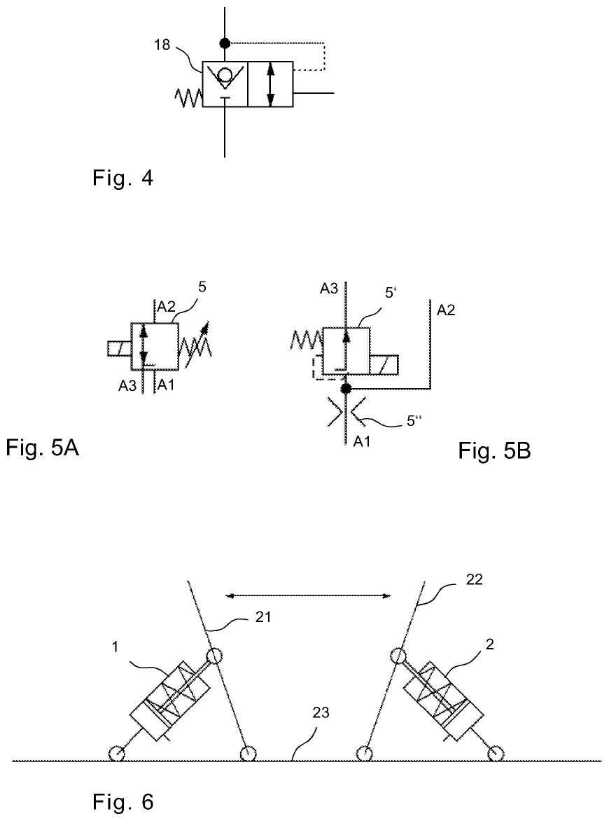

FIG. 4 shows a pressure-controlled closing valve 18 with additional control line for pressure safeguarding, which closing valve can be installed instead of the pressure-controlled closing valves 8, 9. This allows the pressure in the hydraulic cylinders 1, 2 to be limited to a permissible maximum pressure. If this is exceeded, for example by external forces acting on a coupled attachment, the valves 8, 9 open and excess pressure can be relieved via the tank return line 7.

FIGS. 5A and 5B show a comparison of a pressure control valve 5 as used in FIGS. 1 to 3 with a pressure-limiting valve 5′ with additional flow resistance 5″ (throttle) which can be used alternatively as a pressure control device. The ports A1, A2, and A3 are designated according to their functionally correct wiring in the hydraulic circuits of FIGS. 1 to 3.

1. A hydraulic adjustment device, comprising:
two selectively controllable hydraulic cylinders (1, 2);
a hydraulic control circuit for actuating the hydraulic cylinders (1, 2);
the control circuit has a pressure control device (5) for generating an adjustable control pressure in dependence on an electrical control signal, and a pressure-controlled changeover valve (6) which is connected to the pressure control device (5) and which, when a first control pressure value is applied, the pressure-controlled changeover valve (6) assumes a first switching position (S2) in which a first of the hydraulic cylinders (1) is connected to a pressure sink (4) and the a second of the hydraulic cylinders (2) is connected to a pressure source (3), and, when a second control pressure value is applied which is higher than the first control pressure value, the pressure-controlled changeover valve (6) assumes a second switching position (S3) in which the first hydraulic cylinder (1) is connected to the pressure source (3) and the second hydraulic cylinder is connected to the pressure sink (4).

2. The hydraulic adjustment device as claimed in claim 1, wherein the pressure-controlled changeover valve (6), is configured such that when a third control pressure value is applied that differs from the first and the second values, assumes a third switching position (S1) in which both of the hydraulic cylinders (1, 2) are connected to the pressure source (3) or to the pressure sink (4).

3. The hydraulic adjustment device as claimed in claim 2, wherein the control circuit further comprises an electrically switched changeover valve (13) which, either directly or via pressure-controlled valves (8, 9), in a first switching position interrupts a connection to the pressure source (3) or the pressure sink (4) switched via the pressure-controlled changeover valve (6), and in a second switching position connects through.

4. The hydraulic adjustment device as claimed in claim 2, wherein the control pressure from the pressure control device (5) is connected directly to both hydraulic cylinders (1, 2) via check valves (11, 12) at least in the third switching position (S1).

5. The hydraulic adjustment device as claimed in claim 2, wherein the control pressure from the pressure control device (5) is connected directly to one of the two hydraulic cylinders (1, 2) selectively via at least one check valve (11, 12) and a further electrically switchable changeover valve (17) at least in the third switching position (S1).

6. The hydraulic adjustment device as claimed in claim 1, wherein the pressure control device (5) is formed by a pressure control valve (5) or by an adjustable pressure-limiting valve (5′) with a flow resistor (5″).

7. The hydraulic adjustment device as claimed in claim 1, further comprising load signal lines (14, 15) that branch off from pressure lines (8′, 9′) leading to the hydraulic cylinders (1, 2) that are connected to a load pressure signal system (LS) of the pressure source (3), and the pressure source (3) comprises a volume-flow-controllable hydraulic pump.

8. The hydraulic adjustment device as claimed in claim 1, wherein the pressure-controlled changeover valve (6) is configured such that a changeover movement from the first switching position (S2) into the second switching position (S3) is proportional to the control pressure.

9. The hydraulic adjustment device as claimed in claim 1, wherein the hydraulic adjustment device is for transverse adjustment for lower links (21, 22) of a three-point power lift on an agricultural machine.

10. A three-point power lift of an agricultural machine, the three-point power lift comprising:
two laterally pivotable lower links (21, 22), each of which is hydraulically transversely adjustable via a hydraulic cylinder (1, 2);
a hydraulic control circuit for actuating the hydraulic cylinders (1, 2), the control circuit including a pressure control device (5) for generating an adjustable control pressure in dependence on an electrical control signal, and a pressure-controlled changeover valve (6) which is connected to the pressure control device (5) and, when a first control pressure value is applied, the pressure-controlled changeover valve (6) assumes a first switching position (S2) in which a first of the hydraulic cylinders (1) is connected to a pressure sink (4) and the second of the hydraulic cylinders (2) is connected to a pressure source (3), and, when a second control pressure value is applied which is higher than the first control pressure value, the pressure-controlled changeover valve (6) assumes a second switching position (S3) in which the first hydraulic cylinder (1) is connected to the pressure source (3) and the second hydraulic cylinder (2) is connected to the pressure sink (4).

11. The three-point power lift as claimed in claim 10, wherein the pressure-controlled changeover valve (6), is configured such that when a third control pressure value is applied that differs from the first and the second values, assumes a third switching position (S1) in which both of the hydraulic cylinders (1, 2) are connected to the pressure source (3) or to the pressure sink (4).

12. The three-point power lift as claimed in claim 11, wherein the control circuit further comprises an electrically switched changeover valve (13) which, either directly or via pressure-controlled valves (8, 9), in a first switching position interrupts a connection to the pressure source (3) or the pressure sink (4) switched via the pressure-controlled changeover valve (6), and in a second switching position connects through.

13. The three-point power lift as claimed in claim 1, wherein the control pressure from the pressure control device (5) is connected directly to both hydraulic cylinders (1, 2) via check valves (11, 12) at least in the third switching position (S1).

14. The three-point power lift as claimed in claim 11, wherein the control pressure from the pressure control device (5) is connected directly to one of the two hydraulic cylinders (1, 2) selectively via at least one check valve (11, 12) and a further electrically switchable changeover valve (17) at least in the third switching position (S1).

15. The three-point power lift as claimed in claim 10, wherein the pressure control device (5) is formed by a pressure control valve (5) or by an adjustable pressure-limiting valve (5′) with a flow resistor (5″).

16. The three-point power lift as claimed in claim 10, further comprising load signal lines (14, 15) that branch off from pressure lines (8′, 9′) leading to the hydraulic cylinders (1, 2) that are connected to a load pressure signal system (LS) of the pressure source (3), and the pressure source (3) comprises a volume-flow-controllable hydraulic pump.

17. The three-point power lift as claimed in claim 10, wherein the pressure-controlled changeover valve (6) is configured such that a changeover movement from the first switching position (S2) into the second switching position (S3) is proportional to the control pressure.

18. The three-point power lift as claimed in claim 10, wherein the hydraulic cylinders (1, 2) comprise single-acting cylinder-piston units with spring or gas pressure return.
